(19) United States
(12) Patent Application Publication
(10) Pub. No.: US 2025/0029581 A1
(43) Pub. Date: Jan. 23, 2025

(54) CONTROL DEVICE AND KEYBOARD INSTRUMENT

(71) Applicant: YAMAHA CORPORATION, Hamamatsu-shi (JP)

(72) Inventors: Yoshimasa ISOZAKI, Hamamatsu-shi (JP); Katsunori SUZUKI, Hamamatsu-shi (JP); Takahiro TERADA, Hamamatsu-shi (JP); Takashi MORI, Hamamatsu-shi (JP); Jun ISHII, Hamamatsu-shi (JP); Ibuki HANDA, Hamamatsu-shi (JP); Takuya FUJISHIMA, Hamamatsu-shi (JP); Koji YATAKA, Hamamatsu-shi (JP); Yukio WAKUI, Iwata-shi (JP); Soichi TAKIGAWA, Hamamatsu-shi (JP); Akira MAEZAWA, Hamamatsu-shi (JP); Haruki OHKAWA, Hamamatsu-shi (JP); Yoshikatsu MATSUBARA, Hamamatsu-shi (JP); Yasuhiko OBA, Hamamatsu-shi (JP); Fukutaro OKUYAMA, Hamamatsu-shi (JP); Tomoya SASAKI, Hamamatsu-shi (JP); Rei FURUKAWA, Yokohama-shi (JP)

(21) Appl. No.: 18/905,447

(22) Filed: Oct. 3, 2024

Related U.S. Application Data
(63) Continuation of application No. PCT/JP2023/010952, filed on Mar. 20, 2023.

(30) Foreign Application Priority Data
Apr. 6, 2022 (JP) 2022-063525
Oct. 12, 2023 (JP) 2023-177119

(51) Int. Cl. G10H 1/00; G10H 3/18

(52) U.S. Cl. CPC G10H 1/0066; G10H 1/0008; G10H 3/181; G10H 2220/461; G10H 2240/311

(57) ABSTRACT

A control device in one embodiment includes a first transmission unit, a first receiving unit, and a first generation unit. The first transmission unit is configured to transmit first performance data including contents of playing a keyboard instrument at a first communication base to a second communication base. The first receiving unit is configured to receive second performance data from the second communication base. The first generation unit is configured to generate a drive signal to produce a sound in accordance with the second performance data and output the drive signal to a sound generation device at the first communication base. At least one of the first performance data and the second performance data includes a key position signal indicating a key press amount on the keyboard instrument.

### CROSS-REFERENCE TO RELATED APPLICATIONS

This application is a continuation-in-part application of International Patent Application No. PCT/JP2023/010952, filed on Mar. 20, 2023, which claims the benefit of priority to Japanese Patent Application No. 2022-063525, filed on Apr. 6, 2022. This application also claims priority to Japanese Patent Application No. 2023-177119, filed on Oct. 12, 2023. The entire contents of each of the applications mentioned in this paragraph are incorporated herein by reference.

### FIELD

The present invention relates to a control device and a keyboard instrument.

### BACKGROUND

Techniques have been developed in which a plurality of communication bases where musical instruments are played are connected via a network, thereby enabling an ensemble even if the musical instruments are placed at a distant place. A technique for reducing the influence of a communication delay in order to realize a comfortable ensemble is disclosed in, for example, Japanese Laid-Open Patent Publication No. 2005-195982.

### SUMMARY

The control device according to an embodiment includes a first transmission unit, a first receiving unit, and a first generation unit. The first transmission unit is configured to transmit first performance data including contents of playing a keyboard instrument at a first communication base to a second communication base. The first receiving unit is configured to receive second performance data from the second communication base. The first generation unit is configured to generate a drive signal to produce a sound in accordance with the second performance data and output the drive signal to a sound generation device at the first communication base. At least one of the first performance data and the second performance data includes a key position signal indicating a key press amount on the keyboard instrument.

### BRIEF DESCRIPTION OF DRAWINGS

FIG. 1 is a diagram showing a configuration of a communication system according to a first embodiment.

FIG. 2 is a diagram for explaining an internal configuration of an automatic piano according to the first embodiment.

FIG. 3 is a diagram showing a configuration of a control device according to the first embodiment.

FIG. 4 is a diagram for explaining a configuration of an ensemble control function according to the first embodiment.

FIG. 5 is a diagram for explaining a positional relationship between a vibration exciter and a pickup sensor in a second embodiment.

FIG. 6 is a diagram for explaining a configuration of a drive signal generation unit according to the second embodiment.

FIG. 7 is a diagram for explaining a relationship between velocity and delay time in a third embodiment.

FIG. 8 is a diagram for explaining a relationship between velocity and a correction value in the third embodiment.

FIG. 9 is a diagram explaining a structure of an ambient collection device in a communication base T1 in a fourth embodiment.

FIG. 10 is a diagram explaining a structure of an ambient providing device in a communication base T2 in the fourth embodiment.

FIG. 11 is a diagram showing a configuration of a control signal generation unit according to a fifth embodiment.

FIG. 12 is a diagram for explaining a display example of a screen in a sixth embodiment.

### DESCRIPTION OF EMBODIMENTS

In an ensemble performed at a plurality of communication bases, it is difficult for a plurality of performers to obtain a sense of unity from various viewpoints as compared with an ensemble performed at the same place.

According to the present invention, it is possible for a plurality of performers who play an ensemble to obtain a sense of unity.

Hereinafter, an embodiment of the present invention will be described in detail with reference to the drawings. The following embodiments are examples, and the present invention should not be construed as being limited to these embodiments. The configuration described in each embodiment can be applied to other embodiments. In the drawings referred to in the embodiments described below, the same or similar parts are denoted by the same reference signs or similar reference signs (only denoted by A, B, or the like after the numerals), and repetitive description thereof may be omitted. The drawings may be schematically described by omitting a part of the configuration from the drawings for clarity of description.

### First Embodiment

### Communication System

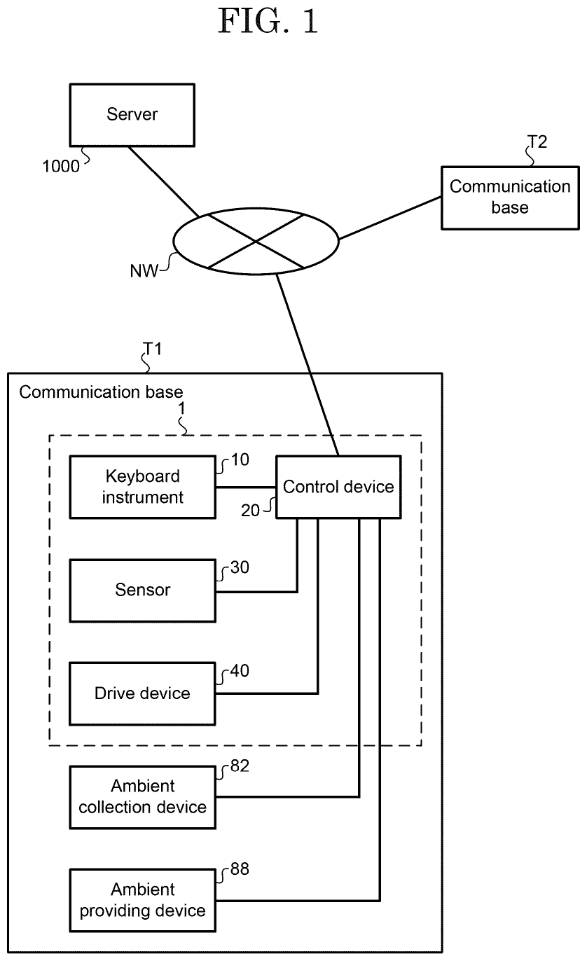

FIG. 1 is a diagram showing a configuration of a communication system according to an embodiment. The communications system includes a server 1000 connected to a network NW, such as the Internet. The server 1000 includes a control unit such as a CPU, a storage unit, and a communication unit. The control unit provides a service for realizing an ensemble between communication bases by executing a predetermined program. The server 1000 controls communication between a plurality of communication bases connected to the network NW, and executes processes required for an automatic piano 1 at the respective communication bases to realize P2P type communication. This process may be realized by a known method. Although two communication bases T1 and T2 are shown in FIG. 1, the number of the communication bases is not limited to this number, and a larger number of communication bases may be present. In the following description, in the case where the communication bases T1 and T2 are described without being distinguished, they are simply referred to as a communication base.

In this case, between the communication base T1 and the communication base T2, information related to the performance at the respective communication bases are exchanged with each other by the P2P communication. The ensemble between the plurality of communication bases is realized by this communication. At each communication base, the automatic piano 1 is arranged. In this example, an ambient collection device 82 and an ambient providing device 88 are connected to the automatic piano 1.

The ambient collection device 82 includes a sensor for collecting information about an ambient environment where the automatic piano 1 is provided, and outputs a collection signal indicating a measurement result of the sensor. The ambient environment is, for example, sound, light, vibration, temperature, air flow, and the like. When the control signal indicating the ambient environment is acquired, the ambient providing device 88 provides an environment based on the control signal. The ambient collection device 82 and the ambient providing device 88 may be integrally formed. The ambient providing device 88 may be provided in accordance with the number of other communication bases. For example, in the case where three communication bases exist in addition to the communication base T1, three environment providing devices 88 may be provided in the communication base T1 corresponding to the respective communication bases. At least one of the ambient collection device 82 and the ambient providing device 88 may be configured to be incorporated in the automatic piano 1. Specific examples of the ambient collection device 82 and the ambient providing device 88 will be described later.

The automatic piano 1 includes a keyboard instrument 10, a control device 20, a sensor 30, and a drive device 40.

### Automatic Piano

Next, a configuration of the automatic piano 1 will be described.

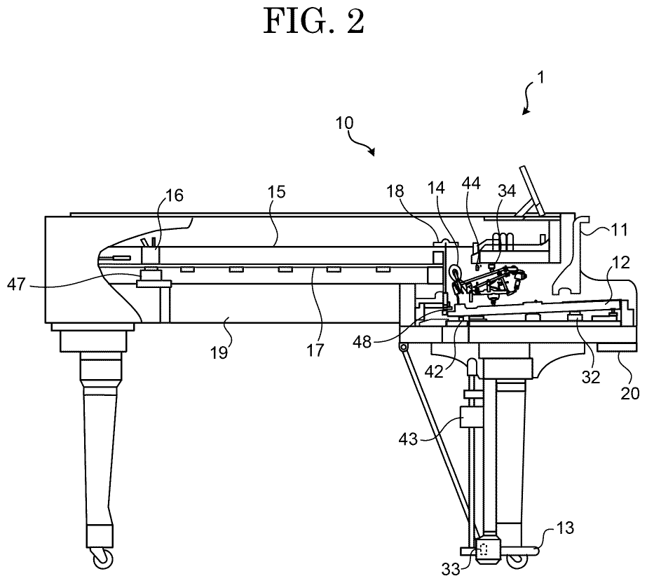

FIG. 2 is a diagram for explaining an internal configuration of the automatic piano according to the first embodiment. Among the automatic piano 1, the keyboard instrument 10 corresponds to, for example, a grand piano. The keyboard instrument 10 includes a plurality of keys 12. The keyboard instrument 10 includes a hammer 14, a string 15, and a damper 18 provided corresponding to each key 12. In the automatic piano 1, a configuration provided corresponding to each key 12 is shown focusing on each configuration provided corresponding to one key 2 shown in FIG. 2. Therefore, description of each configuration provided corresponding to the other keys 12 is omitted. Some configurations, such as the damper 18, may not be provided for some keys 12.

The keyboard instrument 10 includes a plurality of pedals 13. The plurality of pedals 13 is, for example, a damper pedal, a shift pedal, and a sostenuto pedal. In the automatic piano 1, a configuration provided corresponding to each pedal 13 is shown focusing on each configuration provided corresponding to one pedal 13 shown in FIG. 2. Therefore, description of each configuration provided corresponding to the other pedal 13 is omitted. The keyboard instrument 10 further includes a keyboard cover 11, a bridge 16, a soundboard 17, a straight beam 19, and the like.

The sensor 30 includes a key sensor 32, a pedal sensor 33, and a hammer sensor 34. The key sensor 32 is provided corresponding to each key 12, and outputs a measurement signal corresponding to a movement of the key 12 to the control device 20. In this example, the key sensor 32 outputs a measurement signal corresponding to a position (press amount) of the key 12 to the control device 20. The position of the key 12 may be measured in a continuous amount (fine resolution) or by detecting that the key 12 has passed a predetermined position. The position at which the key 12 is detected may be a plurality of positions in a depression range (range from a rest position to an end position) of the key 12.

The hammer sensor 34 is provided corresponding to each hammer 14, and outputs a measurement signal corresponding to a movement of the hammer 14 to the control device 20. In this example, the hammer sensor 34 measures a position of a hammer shank (rotation amount) immediately before the hammer 14 hits the string 15, and outputs a measurement signal corresponding to the measurement result to the control device 20. The position of the hammer shank may be measured in a continuous amount (fine resolution) or by detecting that the hammer shank has passed a predetermined position. The position at which the hammer shank is detected may be a plurality of positions in a range immediately before the hammer 14 hits the string 15.

The pedal sensor 33 is provided corresponding to each pedal 13, and outputs a measurement signal corresponding to the movement of the pedal 13 to the control device 20. In this example, the pedal sensor 33 outputs a measurement signal corresponding to a position (press amount) of the pedal 13 to the control device 20. The position of the pedal 13 may be detected by a continuous amount (fine resolution) or by passing the pedal 13 through a predetermined position. The position at which the pedal 13 is detected may be a plurality of positions in a depression range (range from a rest position to an end position) of the pedal 13.

The drive device 40 includes a key drive device 42, a pedal drive device 43, a stopper 44, a vibration exciter 47, and a damper drive device 48. The key drive device 42 is provided corresponding to each key 12, and is driven to depress the key 12 under the control of the control device 20 using a drive signal. This mechanically reproduces the same situation as when the player presses the key 12. The pedal drive device 43 is provided corresponding to each pedal 13, and drives the pedal 13 to be depressed by control using the drive signal from the control device 20. This mechanically reproduces the same situation as when the player depresses the pedal 13. The damper drive device 48 is provided corresponding to each damper 18, and drives the damper 18 away from the string 15 under the control of the control device 20 using the drive signal. The damper drive device 48 may be configured to drive all the dampers 18 at the same time.

The stopper 44 is driven by control from the control device 20 so as to be present at one of a position where it collides with the hammer shank (blocking position) and a position where it does not collide with the hammer shank (retracted position). In the case where the stopper 44 is at the blocking position, when the key 12 is depressed, a motion of the hammer shank is restricted and the hammer 14 does not hit the string 15. In the case where the stopper 44 is at the retracted position, when the key 12 is pressed, the hammer 14 interlocked with the key 12 hits the string 15. When the string 15 is hit, the keyboard instrument 10 generates a sound.

In this example, the vibration exciter 47 is supported by a support portion connected to the straight beam 19 so as to be in contact with a surface of the soundboard 17 opposite to a portion where the bridge 16 is disposed. The vibration exciter 47 vibrates the soundboard 17 by control using a drive signal from the control device 20. For example, when a drive signal including a piano sound is supplied from the control device 20, the vibration exciter 47 applies vibration corresponding to the drive signal to the soundboard 17. As a result, the piano sound is output from the soundboard 17. A plurality of vibration exciters 47 may be arranged to contact the soundboard 17. Instead of the vibration exciter 47 that vibrates the soundboard 17, a speaker that emits sound may be used.

Sound generation by the keyboard instrument 10 includes a case where the sound is realized by hitting the string 15 by the hammer 14, and a case where the sound is realized by vibrating the soundboard 17 by the vibration exciter 47. Therefore, the keyboard instrument 10 may include a sound generating device that generates a striking tone by driving the key 12, and a sound generating device that generates a sound from the soundboard 17 by driving the vibration exciter 47. The driving of the key 12 and the driving of the vibration exciter 47 are realized by outputting the drive signal to the drive device 40 as described later.

A configuration of the control device 20 will be described. In this example, the control device 20 is attached to the keyboard instrument 10. The control device 20 may not be a device attached to the keyboard instrument 10, and may be, for example, a personal computer, a tablet computer, a smartphone, or the like.

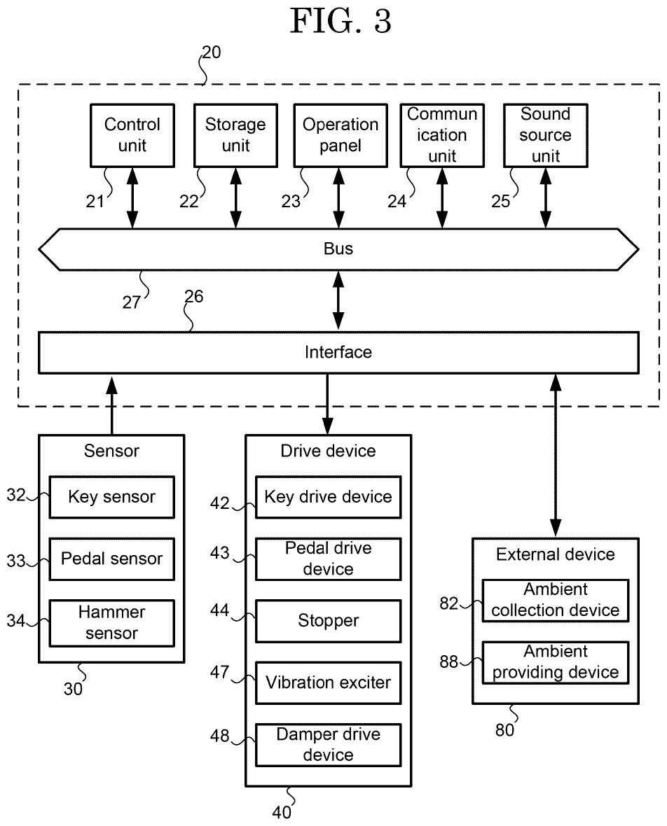

FIG. 3 is a diagram showing a configuration of a control device according to the first embodiment. The control device 20 includes a control unit 21, a storage unit 22, an operation panel 23, a communication unit 24, a sound source unit 25, and an interface 26. These components are connected via a bus 27.

The control unit 21 is an exemplary computer including a processor such as a CPU and a storage device such as a RAM. The control unit 21 executes a program stored in the storage unit 22 using a CPU (processor), and causes the control device 20 to realize functions for executing various processes. The functions realized in the control device 20 include an ensemble control function which will be described later. This ensemble control function controls the components of the control device 20 and the components connected to the interface 26. The sensor 30 and the drive device 40 are connected to the interface 26. In this example, an external device 80 is further connected to the interface 26. The interface 26 transmits a drive signal, a control signal, and the like generated by the control unit 21 to a target configuration, and receives a measurement signal, a collection signal, and the like from each target configuration.

The storage unit 22 is a storage device such as a nonvolatile memory or a hard disk drive. The storage unit 22 stores a program executed by the control unit 21 and various kinds of data necessary for executing the program.

The operation panel 23 includes an operation button or the like for accepting an operation by a user. When the operation by the user is received by the operation button, an operation signal corresponding to the operation is output to the control unit 21. The operation panel 23 may have a display screen. In this case, the operation panel 23 may be a touch panel in which a touch sensor is combined with a display screen.

The communication unit 24 is a communication module that communicates with other devices by wireless, wired, or the like. In this example, the other device with which the communication unit 24 performs communication is server 1000 or the automatic piano 1 in another communication base. In this example, performance data indicating the performance content of the keyboard instrument 10, ambient data, and the like are communicated between the communication bases.

The sound source unit 25 generates a sound signal under the control of the control unit 21. The sound signal is used as a drive signal (a vibration excitation drive signal to be described later) for driving the vibration exciter 47. The sound signal, in this example, includes a signal indicative of the sound of the piano. For example, the control unit 21 controls the sound source unit 25 to generate a sound signal indicating the sound of the piano corresponding to the performance content corresponding to the performance data. The performance data may be data generated based on a measurement signal generated by the sensor 30. The performance data may be, for example, data in a MIDI format including sound generation control information such as note-on, note-off, note-number, and velocity, or information directly indicated by the measurement signal.

The interface 26 is an interface for connecting the control device 20 and each external configuration. In this example, each configuration connected to the interface 26 includes the sensor 30, the drive device 40, and the external device 80 as described above. The interface 26 outputs the measurement signal output from the sensor 30 to the control unit 21. The interface 26 outputs a drive signal for driving each device to the drive device 40. The drive signal is generated by an ensemble control function 100 described later. The interface 26 may include a headphone terminal to which a sound signal indicating a piano sound generated by the sound source unit 25 is supplied.

### Ensemble Control Function

Next, the ensemble control function realized by the control unit 21 executing the program will be described. A configuration for realizing the ensemble control function is not limited to the case where the configuration is realized by the execution of the program, and at least a part of the configuration may be realized by hardware. The configuration for realizing the ensemble control function may be realized not by the control device 20 but by a device connected to the interface 26 (for example, a computer in which this program is installed).

In this example, when the ensemble control function is realized, the control unit 21 controls the stopper 44 to be disposed at the blocking position. In this case, when the user inputs a performance operation to the key 12 and the pedal 13, striking is prevented by the stopper 44, and a sound signal corresponding to the performance operation (for example, a piano performance sound) is generated in the sound source unit 25. The vibration exciter 47 vibrates the soundboard 17 by using the sound signal, and is emitted as a sound. A signal for driving the vibration exciter 47 is generated by a drive signal generation unit 145 described below.

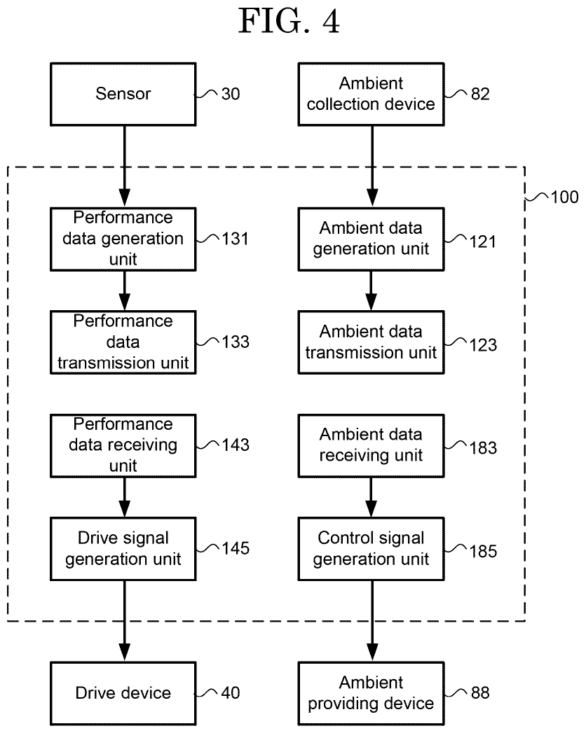

FIG. 4 is a diagram for explaining a configuration of an ensemble control function according to the first embodiment. The ensemble control function 100 includes a performance data generation unit 131, a performance data transmission unit 133, a performance data receiving unit 143, and the drive signal generation unit 145. In this example, the ensemble control function 100 further includes an ambient data generation unit 121, an ambient data transmission unit 123, an ambient data receiving unit 183, and a control signal generation unit 185 as functions for sharing an ambient environment of the automatic piano 1 between the communication bases in association with the ensemble.

The performance data generation unit 131 generates performance data indicating the performance content of the keyboard instrument 10 based on the measurement signal output from the sensor 30. In this example, the performance data includes a measurement signal output from the key sensor 32 (hereinafter, referred to as a key position signal) and a measurement signal output from the pedal sensor 33 (hereinafter, referred to as a pedal position signal). In this example, the key position signal includes a pitch of the pressed key 12 and a press amount of the key 12. If the key sensor 32 is a sensor that measures the press amount of the key 12 at four positions, information of the press amount of the key 12 included in the key position signal indicates one of the four positions.

In this example, the pedal position signal includes a type of the depressed pedal 13 and a press amount of the pedal 13. If the pedal sensor 33 is a sensor that measures the press amount of the pedal at three positions, information on the press amount of the pedal 13 indicates one of the three positions. The performance data may further include a measurement signal output from the hammer sensor 34 (hereinafter referred to as a hammer position signal). The hammer position signal includes, for example, a pitch of a key and a rotation position of the hammer 14.

Assume that the performance data generated by the performance data generation unit 131 is data (for example, a MIDI format) including sound generation control information generated based on the measured results of the key sensor 32 and the pedal sensor 33. In this case, for example, in order to transmit the note-on, the press amount of the key 12 needs to proceed to a state where the note-on is generated.

On the other hand, according to the performance data generation unit 131 in this example, the press amount of the key 12 can be sequentially transmitted at a stage in which the key 12 is being pressed. Therefore, it is possible to cause the automatic piano 1 of another communication base to recognize that the key 12 has started to be pressed even before the note-on. For example, in the automatic piano 1 of the communication base T1, when the key 12 starts to be pressed, the key 12 in the automatic piano 1 of the communication base T2 can be started to be driven so as to have the recognized press amount even prior to the note-on. By doing so, the key 12 can be driven so as to follow the key 12 in the communication base T1 with a short delay period even at the communication base T2.

The performance data transmission unit 133 transmits the performance data generated by the performance data generation unit 131 to another communication base.

The performance data receiving unit 143 receives performance data transmitted from another communication base.

The drive signal generation unit 145 generates a drive signal used in the drive device 40 based on the performance data received by the performance data receiving unit 143. The drive signal includes a signal supplied to the key drive device 42 (key drive signal), a signal supplied to the pedal drive device 43 (pedal drive signal), and a signal supplied to the vibration exciter 47 (vibration excitation drive signal).

The key drive signal is generated based on the performance data, and more specifically, based on the key position signal included in the performance data. The key drive signal is a signal for controlling the key drive device 42 to drive the key 12 so as to reproduce the press amount corresponding to the key position signal. The key 12 to be driven is a key corresponding to the pitch specified by the key position signal. The pedal drive signal is generated based on the performance data, and more specifically, based on the pedal position signal. The pedal drive signal is a signal for controlling the pedal drive device 43 so as to move the pedal corresponding to a type specified by the pedal position signal to a position corresponding to the press amount.

The vibration excitation drive signal is generated based on the performance data, and more specifically, is a signal generated by the sound source unit 25 based on the key position signal and the pedal position signal. When the vibration exciter 47 vibrates the soundboard 17 by the vibration excitation drive signal, the sound (piano sound in this example) corresponding to the signal generated by the sound source unit 25 spreads around the keyboard instrument 10 via the soundboard 17.

When generating the sound signal in the sound source unit 25, the drive signal generation unit 145 may generate the sound generation control information based on the key position signal and the pedal position signal, and cause the sound source unit 25 to generate the sound signal based on the sound generation control information. In this case, the drive signal generation unit 145 may generate the sound generation control information by using an operation for predicting a timing at which the note is turned on and the velocity based on a change in the press amount of the key 12 indicated by the key position signal in the performance data. The change in the rotation position of the hammer 14 indicated by the hammer position signal in the performance data may be used for prediction calculation. As the prediction calculation, a learned model obtained by machine learning in advance may be used, or a fitting process assuming a constant velocity trajectory, a constant acceleration trajectory, or the like may be used from a change in the press amount. As a result, it is possible to improve the prediction accuracy even if motions of the key 12 and the hammer 14 are not aligned. For example, the drive signal generation unit 145 may predict final striking velocity of the hammer 14 at a predetermined position (for example, 6.3 mm/10 mm) in the middle of pressing the key 12, and may output a note-on event. By outputting the note-on event early, the delay as a whole can be reduced.

Assume that the key 12 is driven based on the performance data, and the resulting hammer 14 strikes the string 15. In this case, it takes time to drive the key 12 from a sound generation instruction (for example, note-on), and thus the timing of sound generation is delayed. Therefore, a timing of the sound generation is affected by the delay when the key 12 is driven in addition to the influence of the communication delay between the communication bases.

On the other hand, according to the drive signal generation unit 145, although the key 12 and the pedal 13 are driven by the key drive signal and the pedal drive signal, the striking of the hammer 14 on the string 15 is prevented by the stopper 44, so that a striking sound is not generated. Instead, the vibration exciter 47 is driven by the vibration excitation drive signal, so that the sound is emitted from the soundboard 17. Sound generation using the vibration exciter 47 does not require driving of the key 12. Therefore, with respect to time from the sound generation instruction (for example, note-on) to the actual sound generation, time in the case of the sound generation by the vibration exciter 47 is shorter than time in the case of the sound generation by the strike.

In this case, since the sound generation by the vibration exciter 47 and the driving of the key 12 are controlled separately, the timings are shifted from each other. On the other hand, since an amount of the deviation is small, effects on the user's feeling is small.

The transmitted performance data and the sound generation method are not limited to the above combinations. For example, although the press amount of the key 12 may not be transmitted as performance data, the sound generation control information may be transmitted as performance data. Even in this case, by using the sound generation by the vibration exciter 47 as described above, it is possible to shorten the time difference of the sound generation between the communication bases as compared with the case of using the sound generation by the hitting string.

Each drive signal is generated based on the sound generation control information in the performance data. In this case, the value of the velocity of the key drive signal in the sound generation control information may be increased to be equal to or greater than a predetermined value. In the case where the value of the velocity is small, that is, in the case where pressing speed of the key 12 is slow (in the case where rotation speed of the hammer 14 is small), the key drive device 42 decreases driving speed of the key 12.

In this case, the slower the drive speed is set due to characteristics of solenoid, the later the key 12 moves than a scheduled timing in some cases. It is conceivable to increase the velocity value in order to compensate for the delay. If the velocity value is increased, the delay time when the key 12 is driven is shortened, but the striking tone is increased. However, in this example, since the striking of the hammer 14 is blocked by the stopper 44 and no striking sound is generated, there is no influence on the sound generation. Therefore, the value of the velocity can be increased for the key 12 that does not contribute to sound generation. For example, in the case where the velocity is equal to or less than a predetermined value, the key 12 may be driven by rounding up the velocity to any value greater than or equal to the predetermined value. In this way, the delay may be reduced. For the vibration excitation drive signal, the velocity value is not changed so that the sound generation content does not change. In this case, in order not to affect the performance of the user, some keys 12 may not be driven. The key 12 that is not driven may be a key of a pitch used for a performance song by setting the performance music in advance.

As another example, rather than using sound generation by a vibration exciter, driving the key 12 and sound generation by striking a string may be used by setting the stopper 44 at the retracted position. Even in this case, by transmitting the press amount of the key 12 as the performance data, it is possible to shorten the time difference of the sound generation between the communication bases as compared with the case where the sound generation control information is transmitted as the performance data as described above. In this case, a sound generated by the user's performance operation (for example, the sound generated by the performance in the communication base T1) and a sound generated by the performance in the other communication base (for example, the communication base T2) all include striking sounds. In this case, when the velocity is equal to or less than a predetermined value, the key 12 may be driven by rounding up the velocity to any value greater than or equal to the predetermined value. By doing so, even if the striking tone becomes slightly larger, the reduction of the delay may be prioritized. In this case, when the velocity is equal to or less than the predetermined value, a sound corresponding to the velocity may be generated by the vibration exciter 47 or may be generated by the speaker. By doing so, even if the sound becomes slightly larger, the reduction of the delay may be prioritized.

In this case, the damper 18 may be driven by the damper drive device 48 while preventing the pedal 13 from being driven by the pedal drive device 43 so as not to affect the performance of the user.

As yet another example, sound generation by the vibration exciter 47 may be used while setting the stopper 44 at the retracted position. Instead of the vibration exciter 47, or together with the vibrator 47, sound may be generated by a speaker. In this case, the drive signal generation unit 145 may not generate the key drive signal and the pedal drive signal so that the keys 12 and the pedals 13 do not move. The drive signal generation unit 145 may drive the key 12 at a speed such that sound is not generated by the striking string even if the key 12 is moved by the key drive signal, or at a speed such that sound volume is not a concern even if sound is generated by the striking string. That is, a key drive signal whose velocity is controlled to be equal to or lower than a predetermined value is generated. In this way, the sounds produced by the playing operation by the user include striking sounds, that is, the user can play live sounds. On the other hand, the sound generated by the performance at the other communication base can be the sound generated by the vibration exciter 47 with less delay. That is, by moving the key 12, a feeling that a person is actually playing in a remote place is obtained. Although a plurality of examples has been described with respect to the combination of the transmitted performance data and the sound generation method, it may be possible to set which one is selected by an operation on the operation panel 23.

The ambient data generation unit 121 generates ambient data indicating the ambient environment based on a collection signal output from the ambient collection device 82. In this example, the ambient environment includes images and sounds around the device. Therefore, the ambient collection device 82 includes a device for collecting the ambient environment, that is, a camera (imaging device) for acquiring an image and a microphone (sound collection device) for acquiring sound. In this example, the camera acquires an image of a range in which the player of the keyboard instrument 10 is included.

Although information related to the image included in the ambient data may be image information indicating the image (movie) itself, in this example, the information includes motion information obtained by acquiring motion of the performer by a technique of motion capture. The sensor for measuring the motion of the player is not limited to a camera, and may include an IMU (Inertial Measurement Unit), a pressure sensor, a displacement sensor, and the like. The motion information is, for example, information indicated by coordinates of each portion for a plurality of portions having predetermined features extracted from the image. The ambient data may be transmitted in a form of audio data indicative of a sound signal. In this case, operation information can be synchronized with the sound signal included in the audio data by being transmitted as data of a predetermined channel in the audio data. Similarly, the ambient data may be transmitted to another communication base after a format of the data is converted so as to be transmitted as a part of existing data, such as a format indicating sound generation control information (for example, a MIDI format), a format of movie data, and the like.

The sound collected by the ambient collection device 82 may include a sound (piano sound) generated by a performance on the keyboard instrument 10. A period during which a sound generated by a performance on the keyboard instrument 10 exists can be specified from a key position signal or the like. In the case where the sound generated by the performance is generated by the vibration exciter 47, the sound can be specified by the sound source unit 25. Therefore, when generating the ambient data, the ambient data generation unit 121 may perform signal processing so as to cancel the component of the sound generated by the sound source unit 25 from the sound included in the collected signal.

Even if the sound generated by the performance is a striking sound, the ambient data generation unit 121 may perform signal processing so as to cancel the component of the striking sound from the sound included in the collection signal. The component of the striking sound may be generated by using the key position signal and the pedal drive signal in the sound source unit 25. The ambient data generation unit 121 may generate the ambient data without using the sound included in the collection signal for the period in which the sound caused by the performance of the keyboard instrument 10 exists. In this case, the ambient collection device 82 may recognize the period during which the performance is being performed, so that the sound is not collected during the period.

The ambient data transmission unit 123 transmits the ambient data generated by the ambient data generation unit 121 to another communication base.

The ambient data receiving unit 183 receives ambient data transmitted from another communication base.

The control signal generation unit 185 generates a control signal used in the ambient providing device 88 based on the ambient data received by the ambient data receiving unit 183. The control signal is a signal for reproducing information of the ambient environment included in the ambient data, and in this example, includes a signal for displaying an image on a display (display device) and a signal for outputting sound from a speaker (sound emitting device). Therefore, the ambient providing device 88 includes a display for displaying an image and a speaker for outputting sound. The display may be arranged at a position that is easy for the player to see, such as the keyboard cover 11 and a music stand in the keyboard instrument 10. In the case where an image is displayed on the keyboard cover 11, a projector that projects an image on the keyboard cover 11 may be used instead of the display. In the case where a plurality of communication bases are communication targets, the ambient providing device 88 may be provided corresponding to each communication base. In this case, a control signal supplied to the ambient providing device 88 is generated based on ambient data received from the communication base corresponding to the ambient providing device 88.

The control signal generation unit 185 may generate an image imitating the player using the operation information included in the ambient data, and may generate a signal for displaying the generated image on the display. At this time, an image that emphasizes a specific portion or motion may be generated. The specific portion may be, for example, an eye, a face, a finger, or the like of the player. The specific operation may be, for example, a motion of a line of sight, a motion of the face, a motion of the finger in a performance operation, or the like. The control signal generation unit 185 may generate an image such as a graph showing the motion of the performer in a numerical form by using the operation information included in the ambient data, and may generate a signal for displaying the generated image on the display. The performer can use the displayed information to match the performance.

The control signal generation unit 185 may generate a signal for displaying an image based on the performance data received by the performance data receiving unit 143 on the display. The image based on the performance data may include an image indicating the performance content included in the performance data, for example, a key being operated and an image indicating a pedal.

As described above, according to the ensemble control function 100 of the first embodiment, it is possible to reduce the time difference in the sound generation between the communication bases and to feel the ambient environment of each other close to each other. Therefore, a plurality of performers performing the ensemble can obtain a sense of unity.

### Second Embodiment

The performance content included in the performance data is not limited to the case of indicating a performance operation to the key 12 or the like. In a second embodiment, a description will be given of an example in which a signal indicating the vibration of the soundboard 17 to which the striking sound by the performance is transmitted is included in the performance data. The vibration of the soundboard 17 is measured by a pickup sensor included in the sensor 30 in this example.

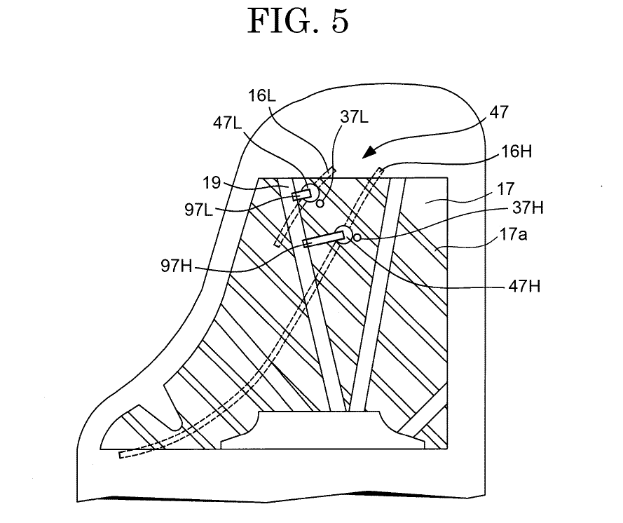

FIG. 5 is a diagram for explaining a positional relationship between the vibration exciter and the pickup sensor in the second embodiment. FIG. 5 is a diagram of the keyboard instrument 10 viewed from below. As shown in FIG. 5, the soundboard 17 is provided with two vibration exciters 47 (vibration exciters 47H and 47L). The vibration exciters 47H, 47L are connected between a plurality of ribs 17a among the soundboards 17. The vibration exciter 47H is provided at a position corresponding to a bridge 16H among the two pieces 16 (the bridge 16H (long piece) and a bridge 16L (short piece)). The vibration exciter 47L is provided at a position corresponding to the bridge 16L. The bridge 16H is a piece that supports the string 15 on a treble side, and the bridge 16L is a piece that supports the string 15 on a bass side. The vibration exciter 47H is supported by a support part 97H connected to the straight beam 19. The vibration exciter 47L is supported by a support part 97L connected to the straight beam 19.

The vibration exciter 47 is not limited to being provided at a position corresponding to the bridge 16 in the soundboard 17, and may be provided at a position away from the bridge 16 or may be provided at a position corresponding to the rib 17a. In the case where the vibrator is provided at a position corresponding to the rib 17a, the vibration exciter 47 may be provided on the string 15 side of the soundboard 17.

A pickup sensor 37H is attached to the soundboard 17 in vicinity of the vibration exciter 47H, measures the vibrations of the soundboard 17, and outputs a measurement signal indicating the measurement result. A pickup sensor 37L is attached to the soundboard 17 in vicinity of the vibration exciter 47L, measures the vibrations of the soundboard 17, and outputs a measurement signal indicating the measurement result. Therefore, the performance data transmitted by the performance data transmission unit 133 to the other communication base and the performance data received by the performance data receiving unit 143 from the other communication base include a measurement signal PU1 from the pickup sensor 37H and a measurement signal PU2 from the pickup sensor 37L.

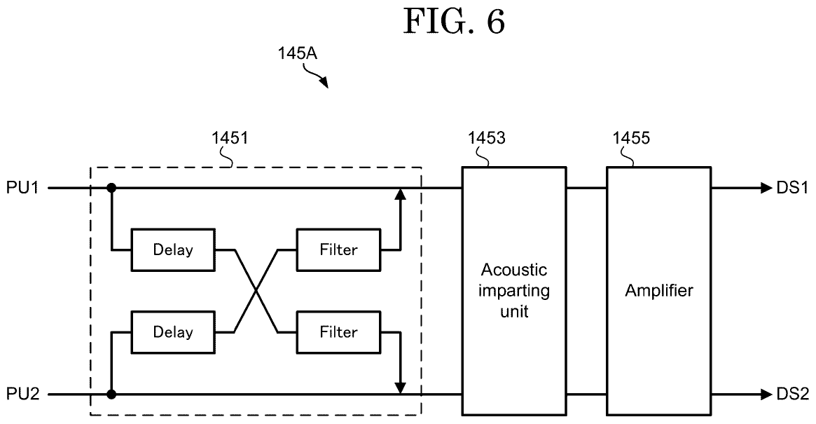

FIG. 6 is a diagram for explaining a configuration of a drive signal generation unit according to the second embodiment. A drive signal generation unit 145A generates vibration excitation drive signals DS1 and DS2 from the measurement signals PU1 and PU2 included in the performance data received by the performance data receiving unit 143. The vibration excitation drive signal DS1 is supplied to the vibration exciter 47H. The vibration excitation drive signal DS2 is supplied to the vibration exciter 47L.

The drive signal generator 145A includes a crosstalk processing unit 1451, an acoustic imparting unit 1453, and an amplifier 1455. The crosstalk processing unit 1451 performs a predetermined delay process and a predetermined filtering process on the measurement signal PU1, and adds the result to the measurement signal PU2. The crosstalk processing unit 1451 performs the predetermined delay process and the predetermined filtering process on the measurement signal PU2, and adds the result to the measurement signal PU1. This reduces the crosstalk components contained in the measurement signals PU1 and PU2.

The acoustic imparting unit 1453 performs a signal process for imparting a sound effect such as a delay, a compressor, an expander, or an equalizer to the measurement signals PU1 and PU2. The amplifier 1455 amplifies the measurement signals PU1 and PU2 to thereby output the vibration excitation drive signals DS1 and DS2 supplied to the vibration exciters 47H and 47L.

For example, in the case where a size and a shape of the soundboard 17 and the like differ between the keyboard instrument 10 in the communication base T1 and the keyboard instrument 10 in the communication base T2, a difference of vibration mode in the soundboard 17 and the like occur. Due to this, the sounds emitted from the respective keyboard instruments 10 are different. Parameters in the signal processes in the crosstalk processing unit 1451 and the acoustic imparting unit 1453 are set corresponding to different configurations of the keyboard instrument 10. This makes it possible to reduce the difference in the sound generation caused by the difference even if the shape of the keyboard instrument 10 and the like at the other communication bases are different.

In the case where an ensemble is performed between a plurality of communication bases, the vibrations of the soundboard 17 measured in the pickup sensors 37H and 37L include not only the vibration caused by the striking sound but also the vibration caused by the vibration exciters 47H and 47L based on the vibration excitation drive signals DS1 and DS2. Therefore, the performance data transmission unit 133 may perform a signal process for reducing components of the vibration excitation drive signals DS1 and DS2 on the measurement signals PU1 and PU2 included in the performance data prior to transmitting the performance data to another communication base.

### Third Embodiment

As described above, in the case where a value of the velocity is small, it takes time to drive the key 12 in the key drive device 42, and a motion of the key 12 is delayed more than when the value of the velocity is large. As described above, in a situation where a striking sound is not generated, the value of the velocity can be increased, but in a case where a striking sound is generated, if the value of the velocity is excessively increased, contents of sound generation is greatly changed. In a third embodiment, an example for reducing such a change in the contents of sound generation as much as possible will be described.

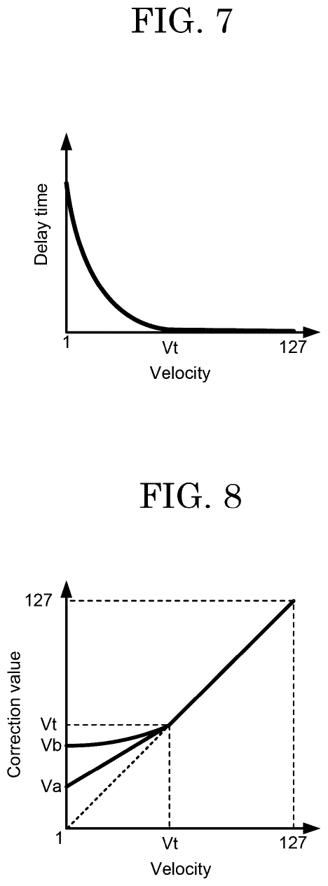

FIG. 7 is a diagram for explaining a relationship between velocity and delay time in the third embodiment. The horizontal axis represents a value of velocity and is a value used as an arithmetic parameter in the drive signal generation unit 145 for generating a key drive signal. The vertical axis corresponds to delay time when the key drive unit 42 drives the key 12 based on the key drive signal. The value of velocity is obtained, for example, from information included in performance data used by the drive signal generation unit 145. More specifically, the value of velocity may be obtained by being calculated from the key position signal or the hammer position signal included in the performance data. In the case where the sound generation control information is included in the performance data, the sound generation control information may be obtained from the value of velocity. In this example, the velocity takes a value from “1” to “127”.

As shown in FIG. 7, as the velocity decreases, the delay time increases. When the velocity is smaller than Vt, the delay time is rapidly increased. Therefore, in this embodiment, the drive signal generation unit 145 corrects the velocity to be larger when the velocity is smaller than Vt.

FIG. 8 is a diagram for explaining a relationship between velocity and a correction value in the third embodiment. As shown in FIG. 8, when the velocity is a value smaller than Vt, a correction value obtained by increasing the value is used as an operation parameter in the drive signal generation unit 145. For example, when the velocity changes from “1” to “Vt”, the correction value is set to change from “Va” to “Vt”. In this way, it is possible to reduce the delay time when the velocity is small. Since the correction value is larger than a value before correction, a louder sound is generated than expected, and on the other hand, a change in volume of the sound has a smaller influence on the listener than the effect of reducing the delay time. In order to make the effect of reducing the delay time stronger, the correction value may be set to be “Vb” which is larger than “Va” when the velocity is “1”.

It is preferable to reduce the delay as much as possible when performing the ensemble. On the other hand, it is preferable that the delay time does not change over the entire input value, rather than decreasing the delay, as long as only sound generation based on the performance data is listened, rather than performing ensemble. Therefore, in such a case, the drive signal generation unit 145 may generate a key drive signal delayed so as to intentionally delay the timing at which the depression of the key 12 is started in a range in which the velocity value is large (a range of a predetermined value or more). In this case, as the input value decreases from “Vt” to “1”, the time for delaying the timing may gradually decrease.

### Fourth Embodiment

In a fourth embodiment, a description will be given of an example in which musical instruments to be played at different communication bases are different. Here, the communication base T1 is a large hall capable of performing by an orchestra. The communication base T2 is a small studio such as a soundproof room. In this case, an orchestral performance is performed at the communication base T1, and a piano performance is performed at the communication base T2. That is, there is no piano performer in the orchestra in the communication base T1, and there is a piano performer in the remote communication base T2.

The performance sound of the orchestra in the communication base T1 is transmitted to the communication base T2. The performer in the communication base T2 plays the automatic piano 1 while listening to the playing sound received from the communication base T1. The performance contents of user is transmitted as performance data from the automatic piano 1 to the automatic piano 1 of the communication base T1. Therefore, the automatic piano 1 in the communication base T1 generates a sound so as to reproduce the performance in the communication base T2. That is, in the communication base T1, even if there is no player of the piano, it is possible to listen to the performance sound of the piano as well as the performance sound of the orchestra. In the fourth embodiment, it is possible to convey the presence of the orchestral performance in the communication base T1 to the performer of the automatic piano 1 in the communication base T2. A configuration for realizing this will be described in detail below.

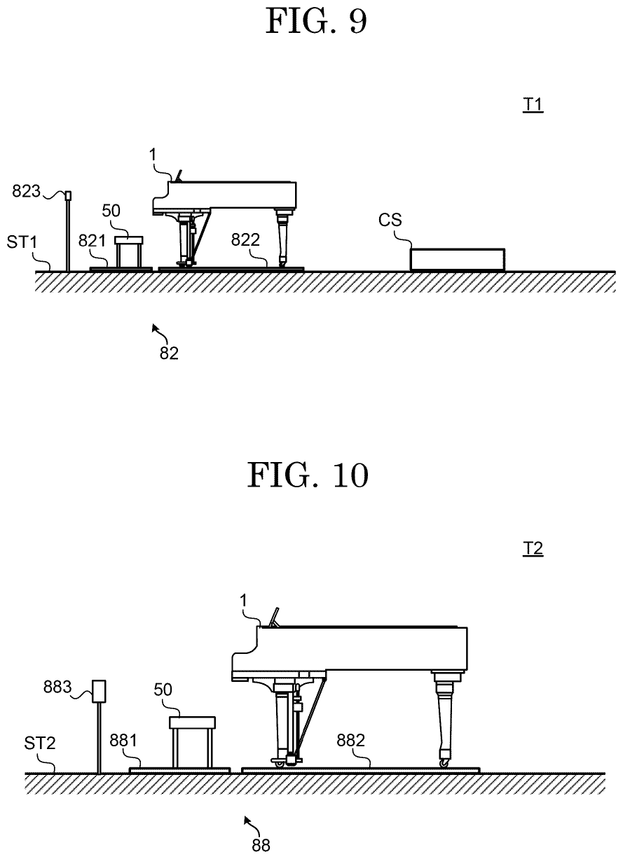

FIG. 9 is a diagram for explaining a structure of an ambient collection device in the communication base T1 according to the fourth embodiment. In the communication base T1, a podium CS, the automatic piano 1, and a chair 50 are installed on a stage ST1 of a hall. The stage ST1 is provided with an ambient collection device 82 including vibration measurement boards 821 and 822 and microphones 823. The vibration measurement board 821 is disposed at a position where the chair 50 is installed on the stage ST1. The vibration measurement board 821 measures vibrations transmitted through the stage ST1 and outputs a collection signal indicative of the measured vibrations. The vibration measurement board 822 is disposed at a location where the automatic piano 1 is installed on the stage ST1. The vibration measurement board 822 measures vibrations transmitted through the stage ST1 and outputs a collection signal indicative of the measured vibrations. In this example, the microphone 823 is located near the chair 50. The microphone 823 collects the arrived sound and outputs a collection signal indicative of the sound.

FIG. 10 is a diagram for explaining a structure of an ambient providing device in the communication base T1 according to the fourth embodiment. In the communication base T2, the automatic piano 1 and the chair 50 are installed on a stage ST2 of the studio. The stage ST2 is provided with the ambient providing device 88 including vibration generation boards 881 and 882 and a speaker 883. The vibration generation board 881 is disposed at a location where the chair 50 is installed on the stage ST2. The vibration generation board 881 vibrates based on the control signal. The vibration generation board 882 is disposed at a location where the automatic piano 1 is installed on the stage ST2. The vibration generation board 882 vibrates based on the control signal. In this example, the speaker 883 is disposed near the chair 50 (near the performer). The speaker 883 emits sound based on the control signal. When the control signals used in the vibration generation boards 881 and 882 and the speaker 883 are generated, a signal process according to vibration characteristics, a signal process for changing transmission characteristics, and the like may be performed.

When the orchestra plays in the communication base T1, the vibrations associated with the performance are transmitted to the vibration measurement boards 821 and 822 via the stage ST1, and the performance sounds are collected in the microphones 823. The collection signals outputted from the vibration measurement boards 821 and 822 and the microphones 823 are transmitted to the communication base T2 as ambient data. When the automatic piano 1 is played in the communication base T2, the performance content is transmitted to the communication base T1 as performance data.

Thus, in the communication base T1, the automatic piano 1 is driven and generates sounds based on the performance data from the communication base T2. That is, the automatic piano 1 in the communication base T1 is driven in accordance with the performance on the automatic piano 1 in the communication base T2. In the communication base T2, the speaker 883 generates sound based on the ambient data from the communication base T1. This sound is the sound collected by the microphones 823 and corresponds to the performance sound of the orchestra in the communication base T1.

Further, the vibration generation board 881 and the vibration generation board 882 are driven to vibrate based on the ambient data from the communication base T1. The vibration in the vibration generation board 881 corresponds to the vibration measured by the vibration measurement board 821 at the communication base T1. That is, the vibrations transmitted to the chair 50 in the communication base T1 are also transmitted to the chair 50 in the communication base T2. The vibration in the vibration generation board 882 corresponds to the vibration measured by the vibration measurement board 822 at the communication base T1. The vibration in the vibration generation board 882 corresponds to the vibration measured by the vibration measurement board 822 at the communication base T1. That is, vibrations that are transmitted to the automatic piano 1 at the communication base T1 are also transmitted to the automatic piano 1 at the communication base T2. Therefore, the performer in the communication base T2 can obtain a sense of realism that the performer is playing in the communication base T1.

The vibration measurement boards 821 and 822 and the microphones 823 in the communication base T1 also collect components of the piano sound by driving the automatic piano 1. Therefore, a signal process is performed to reduce the components of the piano sound in a path until the vibration generation boards 881 and 882 and the speaker 883 are driven in the communication base T2. The components of the piano sound can be generated from a signal for driving the automatic piano 1 in the communication base T1. Therefore, for example, this signal process may be executed by the ambient data generation unit 121 when the ambient data transmitted from the communication base T1 is generated. In this way, in the environment provided by the ambient providing device 88 in the communication base T2, effects of the performance in the communication base T2 can be reduced.

### Fifth Embodiment

In a fifth embodiment, a configuration will be described in which the image of the player (an image of the player transmitted to another communication base) is also displayed when the ambient providing device 88 displays an image of a player at another communication base.

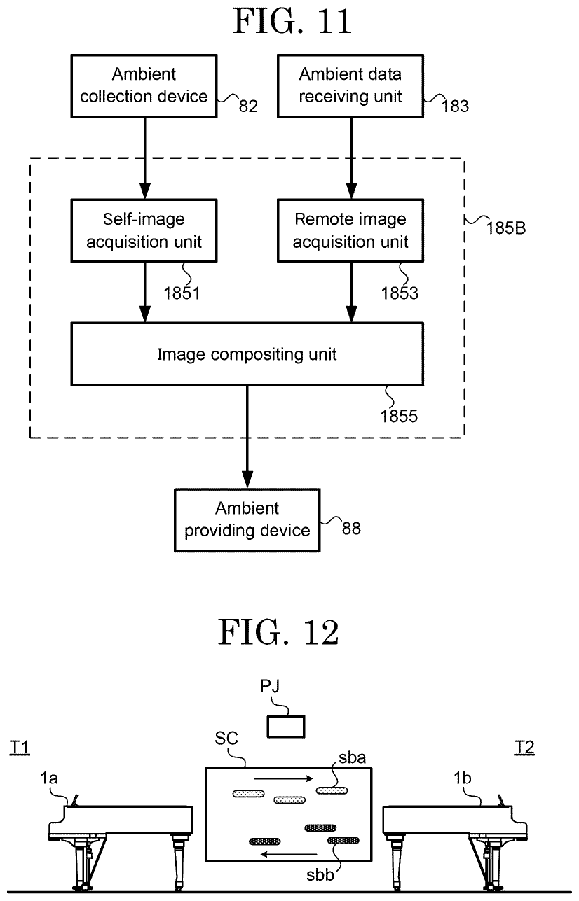

FIG. 11 is a diagram showing a configuration of a control signal generation unit according to the fifth embodiment. A control signal generation unit 185B according to the fifth embodiment includes a self-image acquisition unit 1851, a remote image acquisition unit 1853, and an image compositing unit 1855.

The self-image acquisition unit 1851 acquires self-image information related to an image including a performer on the basis of a collection signal output from the ambient collection device 82. The remote image acquisition unit 1853 acquires remote image information related to an image including a performer collected by the ambient collection device 82 of another communication base based on the ambient data received by the ambient data receiving unit 183. Each of the self-image information and the remote image information is an image including a player and a keyboard portion of the keyboard instrument 10.

The image compositing unit 1855 generates a composite image based on the self-image information and the remote image information. The composite image is an image obtained by extracting an image area of the performer included in the remote image information and superimposing the extracted image area on the image of the self-image information. At this time, the image compositing unit 1855 specifies the keyboard portion from the images in the self-image information and the remote image information, and determines a superimposition position of the image of the player in the remote image information so that keyboard portions of each other match. For example, the image compositing unit 1855 superimposes an image obtained by applying a conversion matrix to the remote image information so as to maximize cross-correlation of the keyboard portions of each other on the image of the self-image information. The image compositing unit 1855 generates a control signal for displaying the composite image and outputs the control signal to the ambient providing device 88. The ambient providing device 88 may be a display that displays a composite image on a display, or may be a projector that projects at least a part of an image of remote image information onto a keyboard portion. In the case where projection is performed using a projector, a predetermined conversion matrix corresponding to a position of the keyboard portion may be applied to the remote image information.

In a continuous play in which two players play one piano, the positions of the players with respect to the keyboard are also different because the ranges played by the respective players are different. Even in the case where the continuous play is divided into two communication bases and played one by one, the position of the performer with respect to the keyboard is almost the same as that in the case where one piano is played. Therefore, the generated composite image is obtained as an image of two performers playing one piano.

In this example, the image compositing unit 1855 determines whether the images of the two performers are in contact with each other, and in the case where the images are in contact with each other, the image compositing unit 1855 corrects the composite image so that an area corresponding to the contact portion can be specified, such as by causing the area to emit light. In this case, the contact portion to be emitted may be limited to a part (for example, an arm or a hand). It is also possible to cause the player to recognize that the images of the two performers come into contact with each other in addition to the images. For example, in the case where the images of two performers come into contact with each other, a seating surface of the chair used by the performer may be vibrated. In this case, a configuration for vibrating the seat surface of the chair is included in the ambient providing device 88 and controlled by a control signal from the control signal generation unit 185B. By doing so, even if the two performers play at different communication bases, they can experience a situation in which the performers actually play at the same place.

The remote image acquisition unit 1853 may acquire the operation information (remote operation information) described above instead of the remote image information. In this case, the image compositing unit 1855 may generate an image imitating the performer using the motion information and synthesize the image with the image of the self-image information to generate a composite image. The image compositing unit 1855 may delay the image of the self-image information and then superimpose the image of the remote image information on the image of the self-image information when generating the composite image in consideration of a temporal deviation (communication delay or the like) between the self-image information and the remote image information, or may generate a future predicted image of the delay time from the image of the remote image information or the remote operation information and superimpose the predicted image on the image of the self-image information.

### Sixth Embodiment

In the sixth embodiment, a case where two communication bases exist in the same room will be described. In this case, there are two automatic pianos 1 that can communicate with each other in one room. In such a case, a screen on which an image related to each performance content is displayed may be arranged between the two automatic pianos 1.

FIG. 12 is a diagram for explaining a display example of a screen in the sixth embodiment. An automatic piano 1a corresponding to the communication base T1 and an automatic piano 1b corresponding to the communication base T2 are arranged in one room. A screen SC on which images are projected by a projector PJ is arranged between the automatic piano 1a and the automatic piano 1b. In this case, the screen SC displays images corresponding to performance data communicated between the automatic piano 1a and the automatic piano 1b.

The displayed image is an image related to a sound corresponding to the performance content, and in this example, is a stripe image represented by a length corresponding to a sound length at a position determined by a pitch and a sound generation timing. In FIG. 12, a stripe image sba is an image showing sounds corresponding to the performance content in the automatic piano 1a, and a stripe image sbb is an image showing sounds corresponding to the performance content in the automatic piano 1b. The strip images sba and sbb are displayed to flow in accordance with a direction of communication.

That is, when the key 12 is pressed in the automatic piano 1a, the strip image sba corresponding to the tone corresponding to the key 12 is displayed on the screen so as to move toward the automatic piano 1b. Here, when the stripe image sba reaches the automatic piano 1b, a sound corresponding to the image may be generated in the automatic piano 1b. In this case, the automatic piano 1b only needs to drive the key 12 after receiving the playing data corresponding to the strip image sba and then delaying the received playing data until the timing is reached. A relationship between the automatic piano 1a and the automatic piano 1b is the same even if they are replaced.

The projector PJ and the screen SC may be referred to as an exemplary ambient providing device 88. In this instance, the ambient providing device 88 is shared by two automatic pianos 1a and 1b.

### Modifications

The present invention is not limited to the embodiments described above, and includes various other modifications. For example, the embodiments described above have been described in detail for the purpose of showing the present invention in an easy-to-understand manner, and are not necessarily limited to those having all the described configurations. Some modification examples will be described below. Although the modification will be described as an example of modifying the first embodiment, it can also be applied as an example of modifying other embodiments. A plurality of modifications may be combined and applied to each embodiment.

(1) The drive signal generation unit 145 may predict the sound generation control information using other information, not limited to the case where the sound generation control information such as note-on is predicted from the change in the press amount of the key 12 indicated by the key position signal in the performance data. The drive signal generation unit 145 may, for example, extract a motion of the player toward the key 12 from the image of the player included in the ambient data, estimate a motion when the key 12 is pressed after a change in the motion of the finger, and predict the sound generation control information. The information indicating the motion of the finger is also information related to the depression of the key 12. Accordingly, an image of the finger or motion of the finger may be acquired at the sensor 30. In this case, the information indicating the motion of the finger may be transmitted as the performance data.

The sensor 30 may have a configuration to detect contact or proximity to key 12. In this case, the performance data generation unit 131 can generate and transmit performance data based on detection results to recognize that the key 12 starts to be pressed at another communication base before the key 12 actually starts to be pressed. This may improve prediction accuracy of the sound generation control information.

In these predictions, a learned model may be used in which a correlation between motion history information such as a motion of the key 12 or a motion of a finger and sound generation control information such as a note-on timing and a value of velocity is machine-learned. The learned model may be generated to correspond to each performer.

The prediction of the sound generation control information as described above is not limited to be applied in the case where the automatic piano 1 is controlled at another communication base, and may be used for various interlocking. For example, the present invention can be applied to a configuration in which a keyboard device and a sound source device are wirelessly connected to each other. For example, when a note-on is generated by pressing a key on a keyboard device and then a note-on is transmitted to a sound source device, a sound generation timing is delayed due to influence of communication delay. On the other hand, by transmitting the motion of the key to the sound source device before the note-on occurs in the keyboard device, the influence of the communication delay can be reduced by a prediction calculation using the motion.

(2) The key position signal generated in response to the pressing of the key 12 to the automatic piano 1 may be used to control the other keys 12 in the same automatic piano 1. For example, in response to the depression of the key 12, the key 12 corresponding to a one-octave high note of the key 12 can be controlled to be interlocked with each other. The interlocking key 12 is not limited to a sound having a one-octave high note, but may be a predetermined sound. The predetermined sound may be determined relative to the pitch of the pressed key 12, or may be determined absolutely, regardless of pitch. In this case, it is possible to reduce the time difference between the depression of the key 12 to be played and the driving of the key 12 to be interlocked by using the key position signal instead of the sound generation control information.
(3) In the control device 20, the performance contents of the automatic piano 1 may be recorded. Recorded data may be data based on the sound generation control information, or data corresponding to a signal output from the sensor 30 such as the key position signal, the hammer position signal, and the pedal position signal.
(4) The performance data transmission unit 133 may include information for setting whether or not to drive the key 12 of the automatic piano 1 in another communication base for each key 12 in the performance data and transmit the information. The presence or absence of driving may be set by the performer at the communication base on the transmitting side during the performance, or may be determined in advance by a specific key or range. At the communication base on the receiving side, the automatic piano 1 drives the vibration exciter 47 without driving the key 12 with respect to a key position signal related to the key 12 set to be not driven.
(5) The ambient collection device 82 may include a sensor that attaches to the player, for example, a sensor that measures the player's breath. The automatic piano 1 may transmit measurement results of respiration of the performer as the ambient data to another communication base, and may display information corresponding to the change in the respiration on the display of the ambient providing device 88 at the other communication base or the like. The respiration of the performer is closely related to performance. For example, just before the performance is started, the player often inhales a large amount of breath. Thus, if it is measured to inhale a large amount of breath, information indicating this or a time period until a performance is considered to be initiated may be displayed on the display. The time period may be set to be different by the performer, assuming that the time period from when the performer inhales a large amount of breath to when the performance starts is different. In the prediction of the time period, a learned model in which the correlation between the timing at which the breath is largely inhaled and the time until the start of the performance is machine-learned may be used.
(6) The ambient providing device 88 may be a small movable device capable of providing various environments, and may be, for example, a shape of a humanoid simulating some character. For example, the ambient providing device 88 may be a humanoid robot in which an arm and a hand move based on a control signal. The ambient providing device 88 may have a shape that can be attached to the player (a wristwatch type, a shoulder type, a neck type, or the like). The configuration for providing various environments may be the display and speaker described above, or may be, for example, a heat source for controlling temperature, a cooling source, a fan, or the like, or may be an illumination, a projector, or the like for controlling the brightness, color, pattern, or the like of a room. The ambient providing device 88 may include, for example, a structure such as a robotic arm for changing a position of a heat source or the like, or may be configured such that a plurality of heat sources are arranged and one of them is driven to substantially change the position of the heat source. The heat source may be used, for example, to reproduce a position of the performer at another communication base. The ambient collection device 82 may include a sensor corresponding to the ambient providing device 88, and may include, for example, a temperature sensor, an air volume sensor, an illuminance sensor, or the like.
(7) The ambient providing device 88 may include a plurality of speakers to localize a sound image or reproduce a predetermined sound field. In this case, a predetermined reverb process or a filtering process such as FIR may be added to the sound signal included in the ambient data. In the ambient collection device 82, information for reproducing sound field characteristics of the room may be collected and transmitted as ambient data to another communication base. Thus, the ambient providing device 88 at the communication base on the receiving side may reproduce the sound field of the room at the communication base on the transmitting side based on the information included in the ambient data. At this time, the sound field of the room at the communication base on the transmitting side may be reproduced more accurately by including the signal processing for canceling the sound field characteristics of the room at the communication base on the receiving side. The process of reproducing such a sound field may be added to the vibration excitation drive signal.
(8) A common metronome synchronized at each communication base may be realized by sound, light, vibration, or the like. In the case where synchronization is performed at an absolute time, for example, time information used in a satellite positioning system such as a GPS signal may be used, or a time synchronization technique based on an NTP (Network Time Protocol) may be used. In this case, a value of BPM may be set, and a beat starting timing may be determined based on the time information. The value of BPM may be determined based on a preset performance song, or may be set by a player.

Instead of using the absolute time as a reference, one of the plurality of communication bases may be used as a reference of the metronome. In this case, beat positions may be analyzed from the performance content at the communication base serving as a reference and used as a metronome. In a case where the beat positions are detected from the performance contents at a plurality of communication bases, the beat positions that can be handled in accordance with the largest number of communication bases may be used as the metronomes at other communication bases. In accordance with these metronomes, predetermined data (data including sound generation control information, sound data, moving image data, and the like) may be reproduced. The predetermined data may be obtained by recording the performance. For example, a rhythm pattern of a drum may be reproduced by metronome setting.

In the case where the metronome is realized by vibration, the player may be allowed to recognize the beat of the metronome by vibrating the movable configuration of the automatic piano 1. For example, the drive signal generation unit 145 may generate a drive signal so as to slightly move the pedal 13 for each metronome beat. An amount of motion of the pedal 13 is a small amount such that the damper 18 does not separate from the string 15 in the case of a damper pedal. The configuration in which the metronome moves for each beat is not limited to the pedal 13, and may be any key 12, and in this case, the key 12 is preferably a depressed amount that does not generate striking or note-on.

(9) Time information when the performance data is transmitted may be included in the transmitted performance data. In this way, it is possible to correct so as to eliminate deviation on a time axis in the communication delay by adjusting the performance data received from the plurality of communication bases on the time axis in accordance with the time information. For example, in the case where the automatic piano 1 is not played or the performance data is not transmitted to another communication base even if the performance is played, even if the performance data from the other plurality of communication bases is received at different timings due to the communication delay, the automatic piano 1 can be driven as having the same delay amount by shifting the performance data on the time axis so that the time information is aligned.

It is possible to recognize the delay time of the performance data that arrives from each communication base by using this time information. The drive signal generation unit 145 may generate a drive signal by decreasing a value of velocity as the delay time increases. The drive signal generation unit 145 may add reverberation as the delay time increases. In this way, it is possible to realize sound generation in which a length of the delay time is as an effect based on magnitude of the distance in the automatic piano 1. That is, it is possible to give the listener a sense that the large delay time is performed at a distant place. For each communication base, an image visually indicating the magnitude of the delay time may be displayed on the display. For the respective communication bases, images visually indicating the magnitude of the delay times may be presented using AR (Augmented Reality). For example, it is only necessary to convert the delay times into a position/distance relation in an AR space and present images related to the respective communication bases.

(10) The control device 20 may compare the performance data between the plurality of communication bases with each other to calculate a correlation degree, and display the correlation degree on the display. The correlation degree may be computed using, for example, a signal process or DNN (Deep Neural Network). In this case, the correlation degree may be calculated using the performance data adjusted so that the time information is aligned between the plurality of communication bases as described above. The control device 20 may analyze the received performance data to identify a code, or identify a beat position to display the identified information on the display. At this time, a code and a beat position having the highest likelihood among the performance data in the plurality of communication bases may be displayed on the display. Light may be applied to the keyboard so that the key 12 corresponding to a constituent tone of the code is recognized by the player.
(11) The control device 20 analyzes the code from the received performance data, and identifies the code as a current code when the likelihood of the code is higher than a predetermined value. In the case where the vibration exciter 47 generates a sound in response to a performance operation on the key 12, the control device 20 controls not to drive the vibration exciter 47 in a performance operation on the key 12 other than the sound corresponding to the code.
(12) The control device 20 analyzes the beat position from the received performance data, and identifies the beat position as a current beat position when the likelihood of the beat position is higher than a predetermined value. In the case where the vibrator 47 produces a sound in response to the playing operation of the key 12, the control device 20 realizes sound generation by the vibration exciter 47 by delaying to a predicted beat position when a press to the key 12 occurs within a range of a predetermined time until a next predicted beat position is reached. In this way, the playing sound may be aligned with the beat position.
(13) The control device 20 specifies a volume from the received performance data, and also specifies a volume of own performance with respect to the automatic piano 1. The volume is specified by, for example, an average value of velocity at a predetermined time period in the past. The drive signal generation unit 145 generates a key drive signal or a vibration excitation drive signal by adjusting the volume of the received performance data so as to approach the volume generated by the performance. In the adjustment of volume, the volume may be gradually changed instead of being changed abruptly. In this way, it is possible to adjust volume balance in the ensemble. The volume balance may be set in advance so that either one of the volumes is relatively large.
(14) The control device 20 may delay the timing of sound generation in response to the depression of the key 12 in the case where sound generation is performed by the vibration exciter 47 in response to the performance operation on the key 12. At this time, the performance data transmitted to the other communication bases and the performance data transmitted from the other communication bases are not delayed. As a result, the player plays the key 12 so as to press the key early in consideration of the delay time, so that influence of the communication delay in the ensemble can be reduced.
(15) In the case where the automatic piano 1 is not installed in any communication base, but the acoustic piano not provided with the sensor 30 and the drive device 40 is installed, the control device 20 may not include a configuration related to the sensor 30 and the drive device 40, and may be configured by a desktop personal computer, a tablet computer, or the like.

In this case, the control device 20 may convert the performance sound into performance data and transmit the performance sound to another communication base. The performance sound may be collected by a microphone, and the control device 20 may generate the performance data by analyzing the constituent sound included in the collected performance sound and converting the constituent sound into the sound generation control information. According to such processing, the present invention can be applied to musical instruments other than pianos.

(16) The ambient collection device 82 may include a sensor that detects opening and closing of the keyboard cover 11, a sensor that detects seating of a player on a chair, and the like. In this case, the ambient providing device 88 may include a display for displaying opening and closing the keyboard cover 11 and the seating of the performer on the chair. The ambient providing device 88 may have a structure for opening and closing the keyboard cover 11 in response to a control signal. In this case, the keyboard cover 11 at another communication base may be interlocked with the opening and closing of the keyboard cover 11 at a specific communication base.
(17) The keyboard instrument 10 in the automatic piano 1 is not limited to an acoustic piano such as a grand piano, and may be an electronic keyboard instrument. The electronic keyboard instrument may be a keyboard device having a structure corresponding to the key 12 or a keyboard device in which the key 12 has a sheet-like structure. In the case of a keyboard device having a sheet-like structure, the keyboard device can be placed on the floor and stepped on and played, so that the keyboard device can be played even in a situation where a hand cannot be used. In the case of a keyboard device that plays with a foot, a range of sound that can be played may be narrow. In such a case, a plurality of players may play the music by using a plurality of keyboard devices in which different sound ranges are set in advance. In the case of a keyboard device having a sheet-like structure, the keyboard device may be disposed on a back surface of a side table of a bed. In this case, a support member supporting the side table may be provided with a rotation mechanism that is switched so that either a front surface or the back surface of the side table faces an upper surface.
(18) At least a part of the functions of the control device 20 may be provided as a plug-in in software for implementing a video conference system.
(19) The network NW connecting the communication bases may be a dedicated line realized by an optical cable or the like.
(20) The ambient collection device 82 and the ambient providing device 88 may include a configuration for detachably attaching to the automatic piano 1. The automatic piano 1 may also include a configuration for attaching the ambient collection device 82 and the ambient providing device 88. In this case, the ambient collection device 82 or the ambient providing device 88 may be connected to the interface 26 by being attached to the automatic piano 1.

The above is the description of the modifications.

As described above, according to an embodiment of the present invention, there is provided a control device including a first transmission unit configured to transmit first performance data including contents of playing a keyboard instrument at a first communication base to a second communication base, a first receiving unit configured to receive second performance data from the second communication base, and a first generation unit configured to generate a drive signal to produce a sound in accordance with the second performance data and output the drive signal to a sound generation device at the first communication base, wherein at least one of the first performance data and the second performance data includes a key position signal indicating a key press amount on the keyboard instrument.

The sound generating device may include a vibration exciter connected to a soundboard of the keyboard instrument. The sound according to the second performance data is generated at the first communication base by vibration of the vibration exciter in response to the drive signal.

The sound generating device may include a key of the keyboard instrument, a hammer linked to the key, and a string struck by the hammer. The sound according to the second performance data is generated at the first communication base by driving the key according to the drive signal. The drive signal is configured to drive the key to reproduce the key press amount in accordance with the key position signal.

The device may further include a second transmission unit acquiring first ambient data according to information of an ambient environment collected by an ambient collection device at the first communication base and transmitting the first ambient data to the second communication base, a second receiving unit receiving second ambient data from the second communication base, and a second generation unit generating a control signal to provide an ambient environment in accordance with the second ambient data and outputs the control signal to an ambient providing device at the first communication base.

What is claimed is:

1. A control device comprising:
a first transmission unit configured to transmit first performance data including contents of playing a keyboard instrument at a first communication base to a second communication base;
a first receiving unit configured to second performance data from the second communication base; and
a first generation unit configured to a drive signal to produce a sound in accordance with the second performance data and output the drive signal to a sound generation device at the first communication base,
wherein at least one of the first performance data and the second performance data includes a key position signal indicating a key press amount on the keyboard instrument.

2. The control device according to claim 1,
wherein the sound generation device includes a vibration exciter connected to a soundboard of the keyboard instrument, and
wherein the sound according to the second performance data is generated at the first communication base by vibration of the vibration exciter in response to the drive signal.

3. The control device according to claim 1,
wherein the sound generation device includes a key of the keyboard instrument, a hammer linked to the key, and a string struck by the hammer,
wherein the sound according to the second performance data is generated at the first communication base by driving the key according to the drive signal; and
wherein the drive signal is configured to drive the key to reproduce the key press amount in accordance with the key position signal.

4. The control device according to claim 1, wherein the first generation unit is further configured to generate the drive signal based on variation of the key press amount in accordance with the key position signal and output the drive signal to the sound generation device.

5. The control device according to claim 4, wherein the first generation unit is further configured to generate the drive signal so that the sound is generated at a predicted timing based on the variation of the key press amount.

6. The control device according to claim 5, wherein the first generation unit is further configured to generate the drive signal so that the sound is generated at a predicted volume based on the variation of the key press amount.

7. The control device according to claim 1, further comprising:
a second transmission unit configured to acquire first ambient data according to information of an ambient environment collected by an ambient collection device at the first communication base and transmit the first ambient data to the second communication base;
a second receiving unit configured to receive second ambient data from the second communication base; and
a second generation unit configured to generate a control signal to provide an ambient environment in accordance with the second ambient data and output the control signal to an ambient sound providing device at the first communication base.

8. The control device according to claim 7,
wherein the information of the ambient environment collected by the ambient collection device at the first communication base includes sound, and
wherein a sound component output from the sound generation device is cancelled in the first ambient data.

9. The control device according to claim 7, wherein the ambient collection device at the first communication base does not collect sound among the information of the ambient environment during a period of performance of the keyboard instrument at the first communication base.

10. A control device comprising:
a first transmission unit configured to transmit first performance data including contents of playing a first keyboard instrument at a first communication base to a second communication base;
a first receiving unit configured to receive second performance data from the second communication base; and
a first generation unit configured to generate a first drive signal and a second drive signal to produce sounds in accordance with the second performance data and output the first drive signal and the second drive signal to a sound generation device at the first communication base,
wherein the second performance data includes a first measurement signal and a second measurement signal indicating a vibration of a soundboard of a second keyboard instrument at the second communication base, and
wherein the first generation unit is configured to reduce crosstalk components in the first measurement signal and the second measurement signal, respectively, to generate the first drive signal and the second drive signal.

11. The control device according to claim 10,
wherein the sound generation device includes a first vibration exciter and a second vibration exciter connected to a soundboard of the first keyboard instrument, and
wherein a sound according to the second performance data is generated by a vibration of the first vibration exciter and the second vibration exciter in response to the first drive signal and the second drive signal respectively.

12. The control device according to claim 10, wherein the first generation unit is further configured to reduce crosstalk components in the first measurement signal and the second measurement signal, respectively, based on a size and a shape of the soundboard of the first keyboard instrument.

13. The control device according to claim 12, wherein the first generation unit is further configured to process the first measurement signal and the second measurement signal to add a predetermined acoustic effect and to amplify the first measurement signal and the second measurement signal, based on the size and the shape of the soundboard of the first keyboard instrument.

14. The control device according to claim 11,
wherein the first performance data includes a third measurement signal and a fourth measurement signal indicating a vibration of a soundboard of the first keyboard instrument, and
wherein the first transmission unit is further configured to reduce a component of the sound in accordance with the second performance data caused by vibrations of the first vibration exciter and the second vibration exciter in the third measurement signal and the fourth measurement signal respectively.

15. The control device according to claim 10, further comprising:
a second transmission unit configured to acquire first ambient data according to information of an ambient environment collected by an ambient collection device at the first communication base and transmit the first ambient data to the second communication base,
a second receiving unit configured to receive second ambient data from the second communication base; and
a second generation unit configured to generate a control signal to provide an ambient environment in accordance with the second ambient data and output the control signal to an ambient sound providing device at the first communication base.

16. A keyboard instrument comprising:
a key;
a soundboard;
the control device, the control device comprising:
a first transmission unit configured to transmit first performance data including contents of playing a keyboard instrument at a first communication base to a second communication base;
a first receiving unit configured to second performance data from the second communication base; and
a first generation unit configured to a drive signal to produce a sound in accordance with the second performance data and output the drive signal to a sound generation device at the first communication base,
wherein at least one of the first performance data and the second performance data includes a key position signal indicating a key press amount on the keyboard instrument; and
a sound generation device generating a sound based on the drive signal at the first communication base,
wherein the sound generation device includes a vibration exciter connected to a speaker or the soundboard, and
wherein the drive signal includes a first drive signal for driving the key to reproduce the key press amount in accordance with the key position signal.

17. The keyboard instrument according to claim 16,
wherein the drive signal includes a second drive signal for driving the speaker or the vibration exciter based on the key position signal, and
wherein the first generation unit is further configured to generate the second drive signal so that the sound is produced at a predetermined position in a middle of pressing the key and at a predicted volume by a time the key reaches the predetermined position.

18. The keyboard instrument according to claim 16,
wherein the first generation unit is further configured to calculate a velocity based on the key position signal, and
wherein, in a case where the velocity is below a predetermined value, the first generation unit is further configured to generate the first drive signal using a value rounded up to a value greater than the predetermined value.

19. The keyboard instrument according to claim 16,
wherein the drive signal includes a second drive signal for driving the speaker or the vibration exciter based on the key position signal, and
wherein the first generation unit is further configured to calculate velocity based on the key position signal and generate the second drive signal so that the sound is produced when the velocity is less than a predetermined value.

20. The keyboard instrument according to claim 16,
wherein the drive signal includes a second drive signal for driving the speaker or the vibration exciter based on the key position signal, and
wherein the first generation unit is further configured to generate the first drive signal with velocity controlled below a predetermined value.
